(19) United States
(12) Patent Application Publication
(10) Pub. No.: US 2008/0177724 A1
(43) Pub. Date: Jul. 24, 2008

(54) Method and System for Indicating Links in a Document

(75) Inventor: Erika Reponen, Tampere (FI)

Correspondence Address: PERMAN & GREEN, 425 POST ROAD, FAIRFIELD, CT, 06824, US

(73) Assignee: Nokia Corporation, Espoo (FI)

(21) Appl. No.: 11/618,042

(22) Filed: Dec. 29, 2006

(51) Int. Cl. G06F 17/30

(52) U.S. Cl. 707/5

(57) ABSTRACT

A method includes requesting a document for display on a computing device, identifying links within the document, assigning a rank to the links, and displaying at least a subset of the assigned ranks within the document.

### BACKGROUND

1. Field

The disclosed embodiments generally relate to displaying a document, and in particular to displaying a ranking of links in the document.

2. Brief Description of Related Developments

A document, when displayed, may include a number of associated links that refer to other locations in the document or to other documents. Currently, there is no displayed or visual indicator of the ranking of links in a document, for example, it may not be possible to see which links are most popular, or what choices, selections, or further navigation others may have made when visiting or viewing the document.

It would be advantageous to indicate a ranking of the links in the document when displayed for viewing.

### SUMMARY

In one embodiment, a method includes requesting a document for display on a computing device, identifying links within the document, assigning a rank to the links, and displaying at least a subset of the assigned ranks within the document.

In another embodiment, an apparatus includes a browser for requesting a document for display on a computing device, a processor configured to identifying links within the document and assigning a rank to the links, and a display for displaying at least a subset of the assigned ranks within the document.

### BRIEF DESCRIPTION OF THE DRAWINGS

The foregoing aspects and other features of the presently disclosed embodiments are explained in the following description, taken in connection with the accompanying drawings, wherein:

FIG. 1 shows a block diagram of a system suitable for practicing the disclosed embodiments;

FIG. 2 shows an exemplary embodiment of a computing device suitable for practicing the disclosed embodiments;

FIGS. 3-6 show exemplary embodiments of a user interface suitable for use with the disclosed embodiments;

FIG. 7 shows an illustration of an exemplary mobile device suitable for practicing the disclosed embodiments;

FIG. 8 shows a block diagram of another exemplary mobile device suitable for practicing the disclosed embodiments;

FIG. 9 is a block diagram illustrating the general architecture of the exemplary mobile devices of FIGS. 7 and 8;

FIG. 10 illustrates one example of a schematic diagram of a communications system in which aspects of the disclosed embodiments may be practiced;

FIG. 11 illustrates a block diagram of an example of an apparatus incorporating features that may be used to practice aspects of the disclosed embodiments; and

FIG. 12 shows a flow diagram of a method according to the disclosed embodiments.

### DETAILED DESCRIPTION

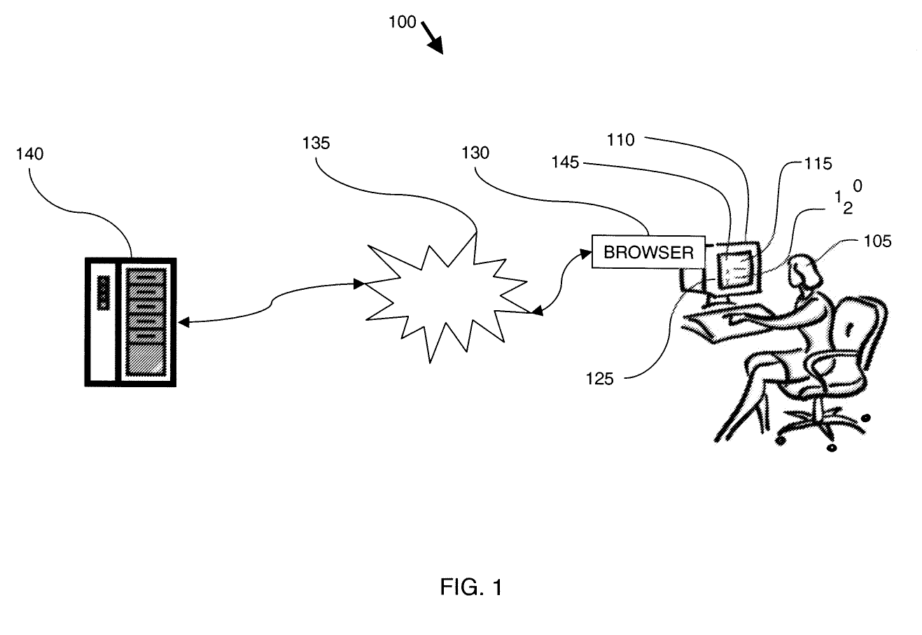

FIG. 1 shows a block diagram of a system 100 suitable for practicing the embodiments disclosed herein. Although the presently disclosed embodiments will be described with reference to the drawings, it should be understood that they may be embodied in many alternate forms. It should also be understood that in addition, any suitable size, shape or type of elements or materials could be used.

The disclosed embodiments generally allow a user 105 of a computing device 110 to view a document 115. Links 120 that may be present in the document 115 are indicated with a ranking or visual indicator of the ranking 125. Typically, a user will request a document. The disclosed embodiments include examining the requested document for links that may be present. The links are analyzed and a ranking is assigned and the ranking indicator and link can be displayed within the document. The ranking may be indicated with any suitable visualization, for example, numbers, letters, images, or any recognizable symbol. The indicator can be any desired font, color, size and can be formatted to present in an active fashion, such as blinking, varying shape or sound, or even produce an audio effect. In alternate embodiments any suitable visual, audio or audiovisual effect can be used as an indicator. In one embodiment, only a subset of the links, for example, the top ten, may be indicated. The indicated rank may be displayed within document, for example, proximate the associated link. Generally the display of the document may be unaffected, with the ranking indicators superimposed on the document. Thus, the disclosed embodiments provide additional information about the document being viewed, provide assistance to a user who may desire advice regarding where to navigate, and may provide information about the behavior of others who have viewed the document. The term “rank” as used herein is generally intended to reference a priority or importance assigned to a link or webpage. This can include for example, a manually assigned ranking or an automatically generated ranking. Rankings can be based on any number of factors including for example, the number of times a link is accessed or page visited.

While the disclosed embodiments are described herein with reference to a “document” it should be understood that for purposes of the disclosed embodiments, a document may include information from a web site or a “web page,” an HTML or XML document, a text document, spreadsheet, graphics presentation, powerpoint presentation, PDF document, multimedia file, or any other suitable information presentation format that may include at least one link. Documents may be stored locally within computing device 110 or may be stored remotely. A link may include a reference or path to a location within a document or to another document. A link may include hypertext as is known in the art.

In alternate embodiments, the disclosed embodiments relate to any machine that is capable of displaying a document, for example a reader or browser. In one embodiment, a browser 130 is used to request information from a network 135, such as for example, the Internet. The information can comprise any suitable information that might be stored or found, such as for example, a document or file. The information, which will generally be referred to as a document herein, may include any information that might be made available, on for example, the Internet or World Wide Web, and may include text, images, graphics, photographs, video or other multimedia information. A reader can read and deliver documents from environments other than including the Internet or the World Wide Web.

Referring again to FIG. 1, the user 105 may browse the network 135 using a browser or browser plug-in 130 on computing device 110. The computing device 110 may be, for example, a personal computer or other device having display capabilities. While the disclosed embodiments are described herein as obtaining a document or web page from a network, the document or web page may be obtained from any suitable medium. The browser may generally include the functionality described herein, or may include an installed plug-in that implements the described functionality.

The term “browser” or “browsing” is used in a known sense herein, to generally mean or refer to software that allows a user to move within a document, from one document to another, from one web page or web site to another, and further allows documents to be displayed, including those from the World Wide Web and the Internet. The term “browser plug-in” is generally used to refer to one or more programs that can be installed to add one or more features or functions to a browser, such as for example, a Web browser. Although the terms “browser” and “browser plug-in” are used herein, the scope of the disclosed embodiments are not intended to be limited by the use of such terms, and in alternate embodiments, any suitable program(s), device(s) or systems that provide the capability to view and retrieve documents and web pages, and add features to such programs or systems, may be used. For purposes of the disclosed embodiments, the term browser will also refer to a browser plug-in.

The user 105 may instruct or request that the browser 130 download data or information, for example from a computer 140 through the network 135. The information may commonly be in the form a document, file or web page of a web site. The form of the data, files or information that can be obtained, retrieved or downloaded is not to be considered limiting as to the scope of the disclosed embodiments. In alternate embodiments, the user 105 may utilize any suitable system or devices to download information and data locally or from the network 135.

As the document 115 is rendered to the browser's user interface, which in the example of FIG. 1 is a display 145 of computing device 110, any links may be identified, and ranking information related to each link may be retrieved or computed. The ranking information once determined may be displayed for each link. In at least one embodiment, the rankings may be displayed within the document, proximate their associated links. In alternate embodiments, the document may be rendered first before the ranking information is displayed, the ranking information may be displayed before the document is rendered, or the ranking information may be displayed while the document is being rendered.

Ranking of links may be accomplished using various methods. For example, links may be categorized by the number of times the link has been activated or the corresponding document has been accessed. Links may also be categorized by ratings provided by users. For example, upon viewing a document, a user may provide a rating of the document's content. Links may then be ranked, or categorized in order, based on their respective ratings. Any other suitable ranking may be used. Ranking data related to a links ratings may be stored with the individual document associated with the link or may stored in a remote repository. For example, ranking data may be stored in computer 140. In one or more embodiments, only a subset of the rankings of the links on a document may be indicated. For example, only the link with the highest ranking may be indicated. As another example, only the links with the top most rankings, such as the top five, may be indicated. As a further example, only the link with the lowest ranking may be indicated. As can be seen, any desirable scheme for indicating ranks of the links in a document may be utilized.

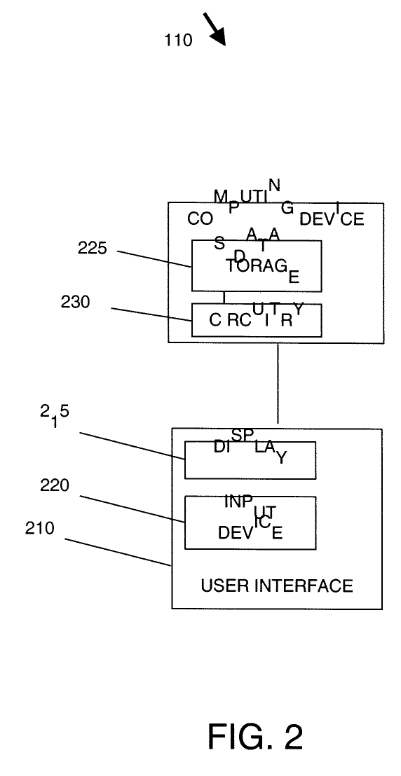

FIG. 2 shows an exemplary embodiment of computing device 110. Computing device 110 may include a user interface 210 including a display 215 and an input device 220. Computing device 110 may also have data storage 225 for storing machine readable program source code which is adapted to cause computing device 110 to perform the operations and methods disclosed herein. Computing device 110 may also have circuitry 230 for performing various functions in hardware.

As mentioned above, a document being displayed may include one or more links. Computing device 110 is generally equipped to recognize the links and to display a ranking or a visual indicator related to the rankings associated with the links. Computing device 110 may have routines included in the machine readable program source in data storage 225 for performing the functions described herein. In addition, computing device 110 may utilize circuitry 130 either alone or in combination with the routines to perform the functions embodied herein.

Computing device 110 may be able to retrieve data related to ratings or rankings for each of the links from data storage 225 or from a remote storage location. Computing device 110 may have calculation or calculator routines included in the machine readable program source in data storage 225 for calculating rankings from the ranking data, or may simply retrieve the rankings themselves. Alternately, computing device 110 may utilize circuitry 230 as a calculator, or a combination of routines and circuitry 230 for identifying links and determining their rankings. When link rankings have been retrieved or determined, computing device 110 may provide them as overlays on the document 115 (FIG. 1).

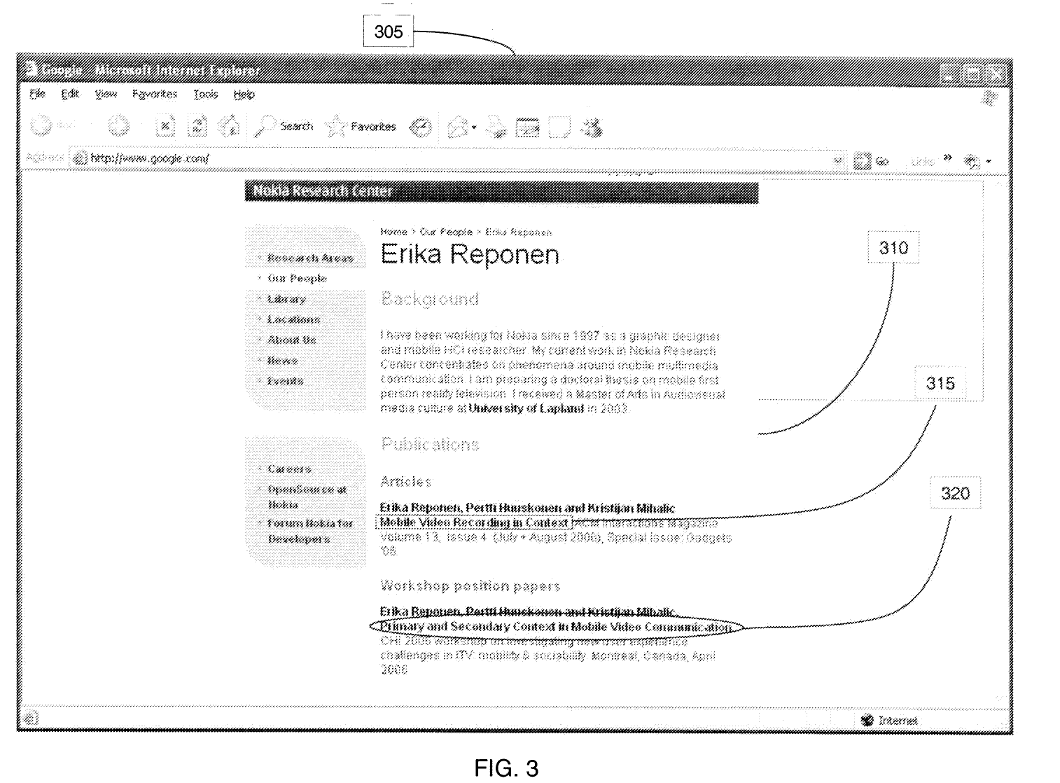

FIG. 3 shows an exemplary user interface embodiment for performing the functions described herein. A user has utilized a browser 305 to navigate to a particular document 310, in this example, a web page. Ranking information is retrieved for the links on the page and the link having the highest ranking, for example, the link accessed the most 315, also referred to as the most popular, may be highlighted with a box. The next most popular link 320 may be highlighted with an ellipse.

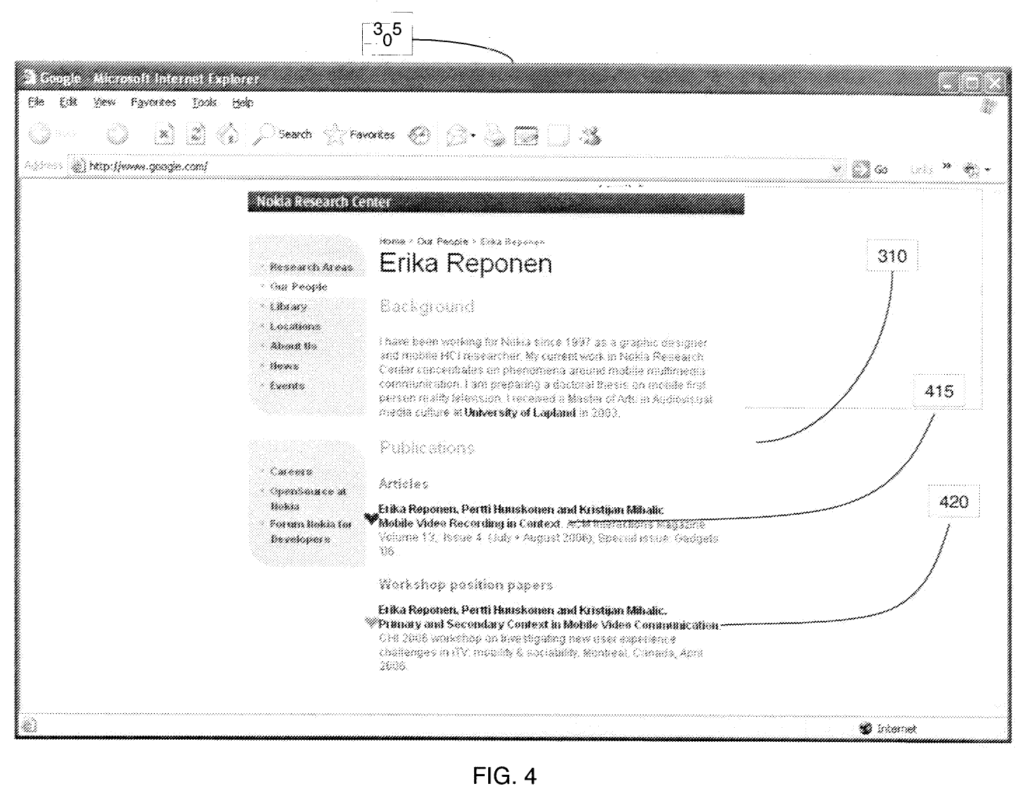

FIG. 4 shows another embodiment where the most popular link 415 is highlighted with a dark symbol, in this example, a heart, while the next most popular link 420 is highlighted with a lighter colored symbol. Thus, the same symbol with different coloring or shading is used to indicate rank.

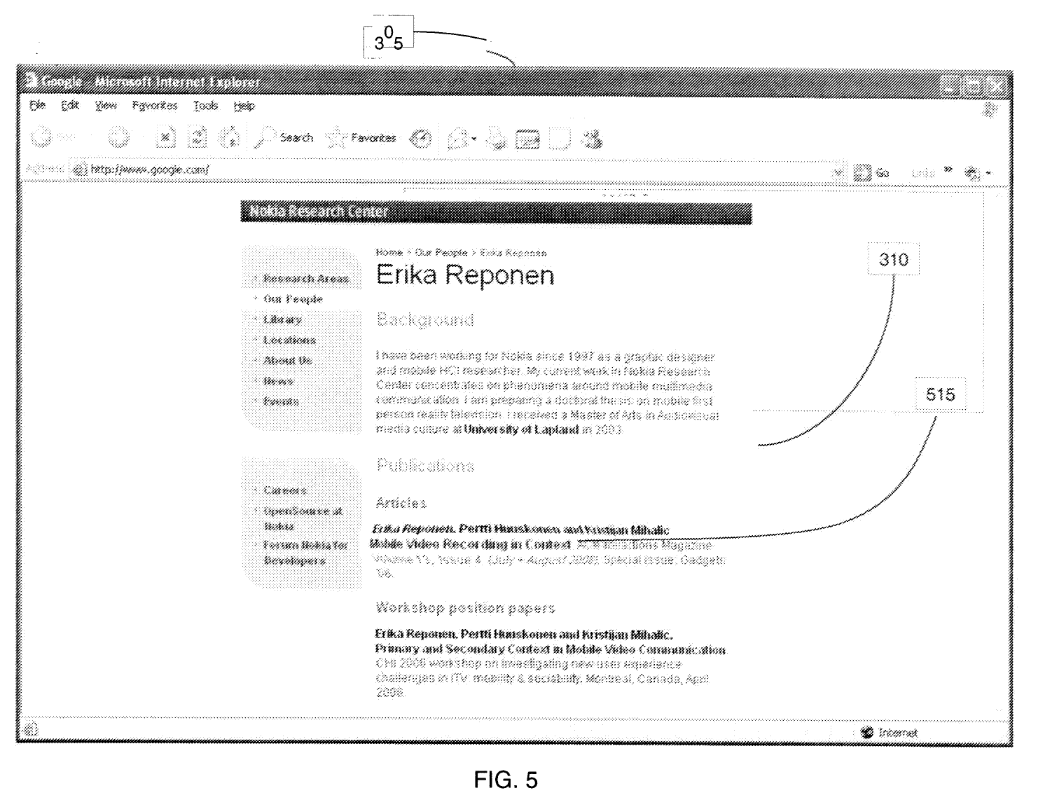

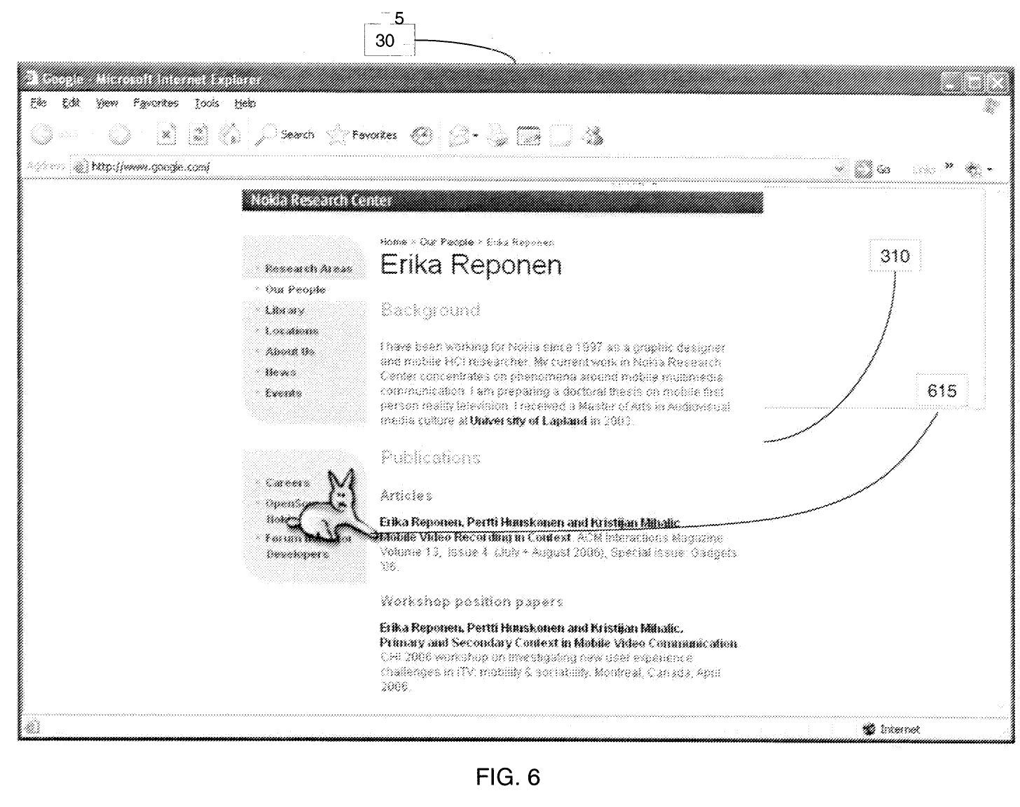

FIG. 5 shows another embodiment where the link with the highest rank, in this example, the most popular link 515, is highlighted with 3D zoom technology, while in FIG. 6, the highest ranking link 615 is indicated with a tamagotchi character. Other characters, for example, alphanumeric characters, may also be used to indicate rank. Any other suitable ranking indicator may also be used, for example, icons, other symbols, shadings, colors, etc.

As mentioned above, the rankings may be indicated within the document 310. In the embodiments shown in FIGS. 3, 4, and 6, the rankings are shown without affecting the document display, and may be superimposed over the document.

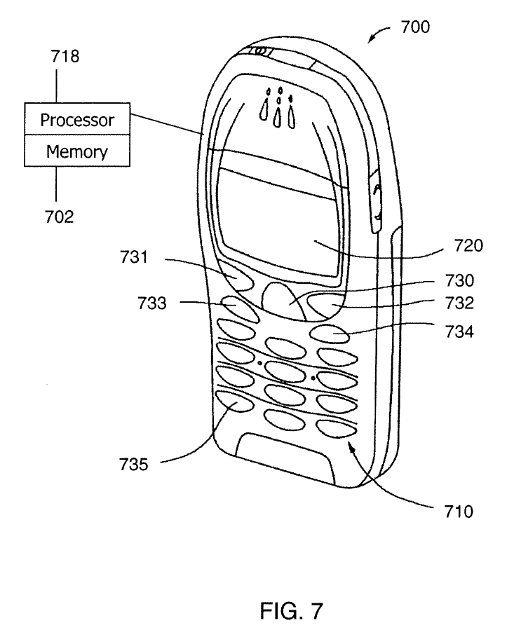

FIG. 7 illustrates another system suitable for practicing the disclosed embodiments. The system of FIG. 7 is embodied as a mobile terminal or communications device 700. The terminal or mobile communications device 700 may have a keypad 710 and a display 720. The keypad 710 may include any suitable user input devices such as, for example, a multi-function/scroll key 730, soft keys 731, 732, a call key 733 and end call key 734 and alphanumeric keys 735. The display 720 may be any suitable display, such as for example, a touch screen display or graphical user interface. The display may be integral to the mobile communications device 700 or the display may be a peripheral display connected to the device 700. A pointing device, such as for example, a stylus, pen or simply the user's finger may be used with the display 720. In alternate embodiments any suitable pointing device may be used. In other alternate embodiments, the display may be a conventional display.

The mobile communications device 700 may also include other suitable features such as, for example, a camera, loud speaker, connectivity port or tactile feedback features. The mobile communications device 700 may have a processor 718 for coordinating the operations of the mobile communications device and for processing user inputs and displaying information on the display 720. A memory 702 may be connected to the processor 718 for storing machine readable program source code adapted to cause device 700 to perform the operations and methods disclosed herein. Memory 702 may also store any suitable information, applications, or programs associated with the mobile communications device 700 such as phone book entries, calendar entries, a web browser, an e-mail client, etc.

Similar to the operations of computing device 110 above, mobile communications device 700 may be equipped to retrieve and display one or more documents, either from a local memory, such as memory 702, or from a remote location. Mobile communications device 700 may be configured to recognize links within the one or more documents, compute a ranking as described herein and provide the document with the ranking indicators to display 720.

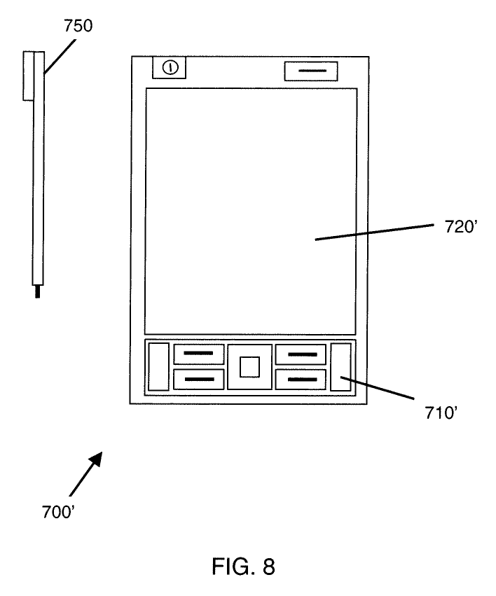

Another system suitable for practicing the disclosed embodiments may be embodied as a PDA style device 700′ illustrated in FIG. 8. The PDA 700′ may have a keypad 710′, a touch screen display 720′ and a pointing device 750 for use on the touch screen display 720′. In still other alternate embodiments, the device may be a personal communicator, a tablet computer, a laptop or desktop computer, a television or television set top box or any other suitable device capable of containing the display 720 and supported electronics such as the processor 701 and memory 702.

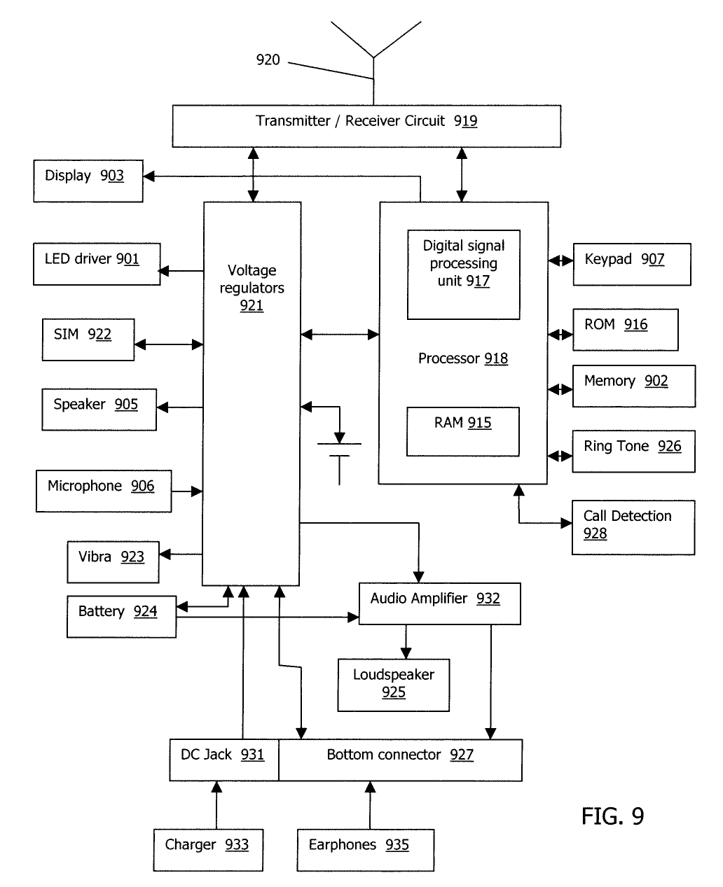

FIG. 9 illustrates in block diagram form one embodiment of a general architecture of the mobile devices 700, 700′. The mobile communications device 700, 700′ may have a processor 918 for controlling the operations of the mobile device, processing user inputs, and displaying information on display 903. The processor 918 may include an integrated digital signal processor 917 and an integrated RAM 915. The processor 918 controls communication with a wireless network via a transmitter/receiver circuit 919 and an antenna 920.

For voice communication, a microphone 906 is coupled to the processor 918 via voltage regulators 921 that transform the user's speech into analog signals. The analog signals converted to digital signals by an A/D converter (not shown) which are then encoded by the digital signal processor 917 in the processor 918. The encoded speech signal is transferred to the processor 918, which e.g. supports, for example, GSM terminal software. The encoded signals are then transmitted to another device by transmitter/receiver circuit 919. Encoded signals from another device are received by transmitter/receiver circuit 919. Digital signal-processing unit 917 speech-decodes the received signals, which are transferred from the processor 918 to the speaker 905 via a D/A converter (not shown). The speaker then reproduces the sounds from the received signals.

The voltage regulators 921 form the interface for the speaker 905, the microphone 906, the LED drivers 901 (for the LEDS backlighting the keypad 907 and the display 903), the SIM card 922, battery 924, the bottom connector 927, the DC jack 931 (for connecting to the charger 933) and the audio amplifier 932 that drives the (hands-free) loudspeaker 925.

The processor 918 may also include or connect to memory 902 for storing any suitable information and/or applications associated with the mobile communications device 700, 700′ such as phone book entries, calendar entries, etc.

The processor 918 also forms the interface for peripheral units of the device, such as for example, a (Flash) ROM memory 916, the graphical display 903, the keypad 907, a ringing tone selection unit 926, and an incoming call detection unit 928. In alternate embodiments, any suitable peripheral units for the device 700, 700′ can be included.

The software in the RAM 915 and/or in the flash ROM 916 includes instructions for the processor 918 to perform a plurality of different applications and functions. In particular, the applications and functions may include the embodiments disclosed herein, including recognizing when a document includes links, retrieving information related to the rankings of the links, computing the rankings where required, and displaying the rankings.

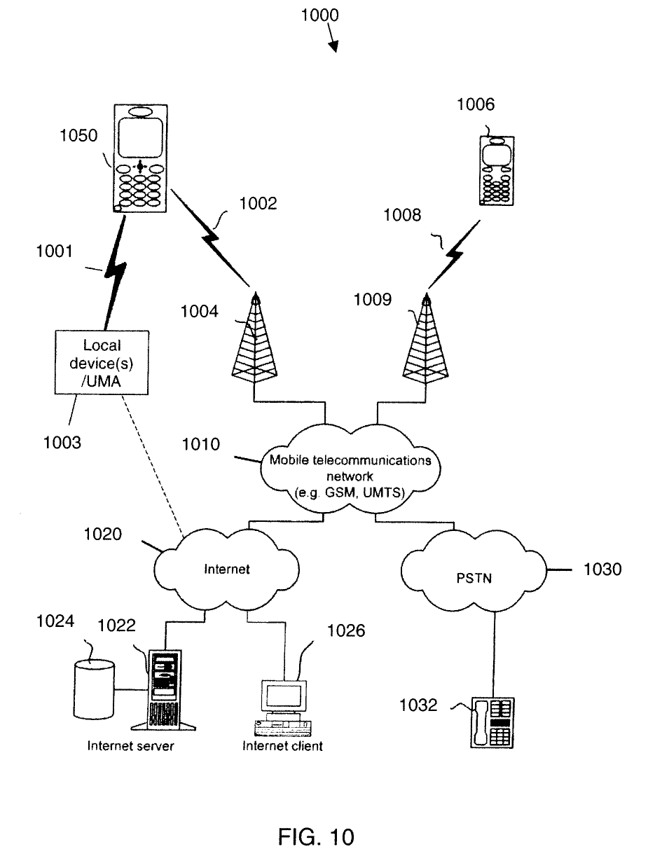

FIG. 10 illustrates an embodiment of a communication system 1000 in which the disclosed embodiments may be used. In the communication system 1000 of FIG. 10, various telecommunications services such as cellular voice calls, www/wap browsing, cellular video calls, data calls, facsimile transmissions, music transmissions, still image transmission, video transmissions, electronic message transmissions and electronic commerce may be performed between the mobile terminal 1050 and other devices, such as another mobile terminal 1006, a stationary telephone 1032, or an internet server 1022. It is to be noted that for different embodiments of the mobile terminal 1050 and in different situations, different ones of the telecommunications services referred to above may or may not be available. The aspects of the disclosed embodiments are not limited to any particular set of services in this respect.

Mobile terminals 1050, 1006 may be similar to and have the same capabilities as mobile terminals 700, 700′ described above. The mobile terminals 1050, 1006 may be connected to a mobile telecommunications network 1010 through radio frequency (RF) links 1002, 1008 via base stations 1004, 1009. The mobile telecommunications network 1010 may be in compliance with any commercially available mobile telecommunications standard such as, for example, GSM, UMTS, D-AMPS, CDMA2000, FOMA and TD-SCDMA or other such suitable communication standard or protocol.

The mobile telecommunications network 1010 may be operatively connected to a wide area network 1020, which may be the Internet or a part thereof. An Internet server 1022 has data storage 1024 and can be connected to the wide area network 1020, as is for example, an Internet client computer 1026. The server 1022 may host a www/wap server capable of serving www/wap content to the mobile terminals 1050, 1006. In alternate embodiments, the server 1022 can host any suitable transaction oriented protocol. For example, a public switched telephone network (PSTN) 1030 may be connected to the mobile telecommunications network 1010 in a familiar manner. Various telephone terminals, including the stationary telephone 1032, may be connected to the PSTN 1030.

The mobile terminal 1050 may also be capable of communicating locally via a local link 1001 to one or more local devices 1003. The local link 1001 may be any suitable type of link with a limited range, such as for example Bluetooth, a Universal Serial Bus (USB) link, a wireless Universal Serial Bus (WUSB) link, an IEEE 802.11 wireless local area network (WLAN) link, an RS-232 serial link, etc. The local devices 1003 can, for example, be various sensors that can communicate measurement values to the mobile terminal 1000 over the local link 1001. The above examples are not intended to be limiting, and any suitable type of link may be utilized. The local devices 1003 may be antennas and supporting equipment forming a WLAN implementing Worldwide Interoperability for Microwave Access (WiMAX, IEEE 802.16), WiFi (IEEE 802.11x) or other communication protocols. The WLAN may be connected to the internet. The mobile terminal 1050 may thus have multi-radio capability for connecting wirelessly using mobile communications network 1010, WLAN or both. Communication with the mobile telecommunications network 1010 may also be implemented using WiFi, WiMax, or any other suitable protocols, and such communication may utilize unlicensed portions of the radio spectrum (e.g. unlicensed mobile access (UMA)).

As implemented in any of mobile terminals 1050, 1006, or Internet client 1026, the present embodiments include the capability of recognizing links within a document, retrieving information related to the rankings of the links, computing the rankings where required, and displaying the rankings. It should be noted that when implemented in a network system such as system 1000, links within a document may refer to locations within the document, other documents stored locally within for example, mobile terminals 1050, 1006, Internet client 1026.

Alternately, the documents may be stored remotely from the implementing device, for example in data storage 1024 connected to Internet server 1022. As such, the documents may be accessed by any number of devices for presentation. It should be understood that the documents may be stored and retrieved from any accessible location in communication system 1000.

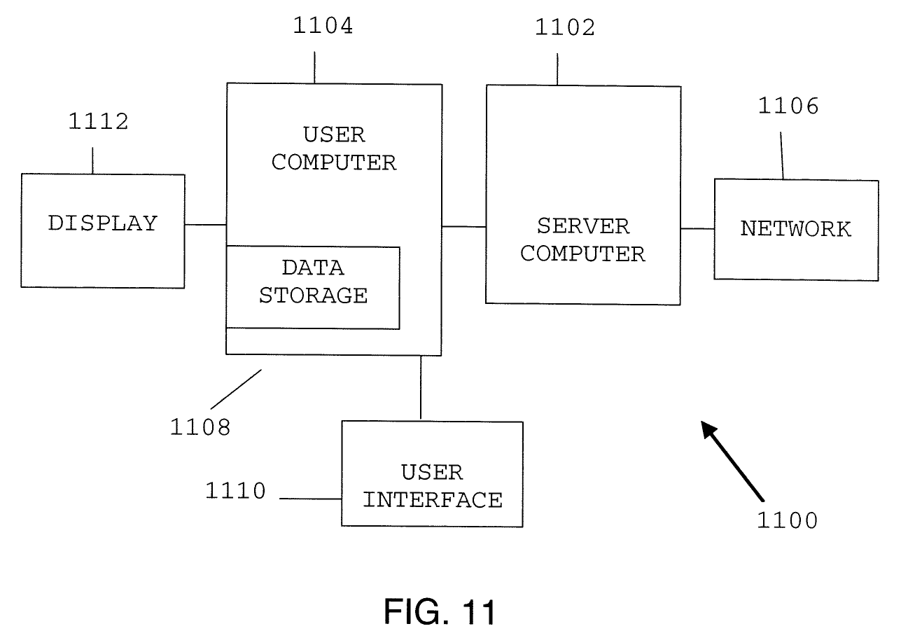

The disclosed embodiments may also include software and computer programs incorporating the process steps and instructions described above that are executed in different computers. FIG. 11 is a block diagram of one embodiment of a typical apparatus 600 incorporating features that may be used to practice aspects of the disclosed embodiments. As shown, a computer system 1102 may be linked to another computer system 1104, such that the computers 1102 and 1104 are capable of sending information to each other and receiving information from each other. In one embodiment, computer system 1102 could include a server computer adapted to communicate with a network 1106. Computer systems 1102 and 1104 can be linked together in any conventional manner including, for example, a modem, hard wire connection, or fiber optic link. Generally, information can be made available to both computer systems 1102 and 1104 using a communication protocol typically sent over a communication channel or through a dial-up connection on ISDN line.

Computers 1102 and 1104 are generally adapted to utilize program storage devices embodying machine readable program source code which is adapted to cause the computers 1102 and 1104 to perform the method steps disclosed herein. The program storage devices incorporating aspects of the disclosed embodiments may be devised, made and used as a component of a machine utilizing optics, magnetic properties and/or electronics to perform the procedures and methods disclosed herein. In alternate embodiments, the program storage devices may include magnetic media such as a diskette or computer hard drive, which is readable and executable by a computer. In other alternate embodiments, the program storage devices could include optical disks, read-only-memory (“ROM”) floppy disks and semiconductor materials and chips.

Computer systems 1102 and 1104 may also include a microprocessor for executing stored programs. Computer 1102 may include a data storage device 1108 on its program storage device for the storage of information and data. The computer program or software incorporating the processes and methods incorporating aspects of the disclosed embodiments may be stored in one or more computers 1102 and 1104 on an otherwise conventional program storage device. In one embodiment, computers 1102 and 1104 may include a user interface 1110, and a display interface 1112 from which aspects of the disclosed embodiments may be accessed. The user interface 1110 and the display interface 1112 can be adapted to allow the input of queries and commands to the system, as well as present the results of the commands and queries.

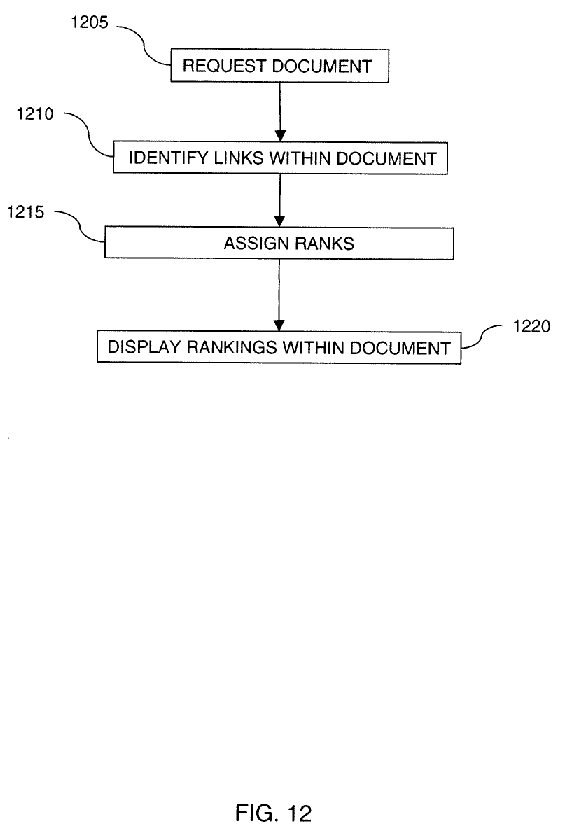

FIG. 12 shows a flow diagram of a method according to the disclosed embodiments. A user requests a document 1205, generally through, for example, computing device 110, mobile terminals 700, 700′, 1006, 1050, or system 1026. Links present in the document are identified 1210, and rankings are assigned 1215. At least a subset of the rankings of the links are displayed within the document 1220.

The disclosed embodiments generally provide a user with the ability to view links within a document and a ranking associated with at least some of the links. This provides additional information about the document and provides the information conveniently within the document. The rankings may aid the user in navigating further and also provide an understanding what links others may have valuable or perhaps not so valuable.

It should be understood that the foregoing description is only illustrative of the present embodiments. Various alternatives and modifications can be devised by those skilled in the art without departing from the embodiments disclosed herein. Accordingly, the embodiments are intended to embrace all such alternatives, modifications and variances which fall within the scope of the appended claims.

What is claimed is:

1. A method comprising:
requesting a document for display on a computing device;
identifying links within the document;
assigning a rank to the links; and
displaying at least a subset of the assigned ranks within the document.

2. The method of claim 1, wherein assigning a rank includes:
retrieving data related to each link; and
utilizing the data to calculate a rank for each link.

3. The method of claim 1, further comprising superimposing the subset of assigned ranks on the document.

4. The method of claim 1, further comprising placing each displayed rank proximate an associated link.

5. The method of claim 1, further comprising indicating the rankings with symbols.

6. The method of claim 1, further comprising indicating the rankings with characters.

7. The method of claim 1, wherein the document is a web page.

8. An apparatus comprising:
a browser for requesting a document for display on a computing device;
a processor configured to identifying links within the document and assigning a rank to the links; and
a display for displaying at least a subset of the assigned ranks within the document.

9. The apparatus of claim 8, wherein the processor is configured to assign a rank by:
retrieving data related to each link; and
utilizing the data to calculate a rank for each link.

10. The apparatus of claim 8, wherein the processor operates to superimpose the subset of assigned ranks on the displayed document.

11. The apparatus of claim 8, wherein the processor operates to place each displayed rank proximate an associated link on the displayed document.

12. The apparatus of claim 8, wherein the processor operates to indicating the rankings with symbols on the displayed document.

13. The apparatus of claim 8, wherein the processor operates to indicating the rankings with characters on the displayed document.

14. The apparatus of claim 8, wherein the document is a web page.

15. An apparatus comprising:
means for requesting a document for display on a computing device;
means for identifying links within the document and assigning a rank to the links; and
means for displaying at least a subset of the assigned ranks within the document.

16. The apparatus of claim 15, wherein the means for assigning a rank is configured to:
retrieve data related to each link; and
utilize the data to calculate a rank for each link.

17. The apparatus of claim 15, wherein the means for displaying operates to superimpose the subset of assigned ranks on the displayed document.

18. The apparatus of claim 15, wherein the means for displaying operates to place each displayed rank proximate an associated link on the displayed document.

19. A user interface comprising:
an input device for requesting a document using a computing device; and
a display connected to the computing device for displaying the document; the computing device configured to identify links within the document, assign a rank to the links, and to display at least a subset of the assigned ranks within the document.

20. The user interface of claim 19, wherein the computing device is configured to assign a rank by:
retrieving data related to each link; and
utilizing the data to calculate a rank for each link.

21. The user interface of claim 19, wherein the computing device operates to superimpose the subset of assigned ranks on the displayed document.

22. The user interface of claim 19, wherein the computing device operates to place each displayed rank proximate an associated link on the displayed document.

23. The user interface of claim 19, wherein the computing device operates to indicating the rankings with symbols on the displayed document.

24. The user interface of claim 19, wherein the computing device operates to indicating the rankings with characters on the displayed document.

25. The user interface of claim 19, wherein the document is a web page.

26. A computer program product comprising:
a computer useable medium having computer readable code means embodied therein for causing a computer to display a document, the computer readable code means in the computer program product comprising:
computer readable program code means for requesting the document for display on the computing device;
computer readable program code means for identifying links within the document and assigning a rank to the links; and
computer readable program code means for displaying at least a subset of the assigned ranks within the document.

27. The computer program product of claim 26, further comprising computer readable program code means for assigning a rank by retrieving data related to each link, and utilizing the data to calculate a rank for each link.

28. The computer program product of claim 26, further comprising computer readable program code means for superimposing the subset of assigned ranks on the displayed document.

29. The computer program product of claim 26, further comprising computer readable program code means for placing each displayed rank proximate an associated link on the displayed document.
